(19) United States
(12) Patent Application Publication
(10) Pub. No.: US 2017/0093673 A1
(43) Pub. Date: Mar. 30, 2017

(54) TRANSMISSION APPARATUS AND TRANSMISSION SYSTEM

(71) Applicant: FUJITSU LIMITED, Kawasaki-shi (JP)

(72) Inventors: Kazuhiro Shibuya, Fujisawa (JP); MASAYUKI ONO, Kawasaki (JP)

(73) Assignee: FUJITSU LIMITED, Kawasaki-shi (JP)

(21) Appl. No.: 15/247,606

(22) Filed: Aug. 25, 2016

(30) Foreign Application Priority Data
Sep. 24, 2015 (JP) 2015-186838

(51) Int. Cl. H04L 12/26

(52) U.S. Cl. CPC H04L 43/0882; H04L 43/0829; H04L 43/0852

(57) ABSTRACT

A transmission side counts the number of data signals to be transmitted to an internal signal route (or a transmission path) and sets a transmission counter value counted at a timing when a monitor signal is transmitted into a monitor signal to be transmitted to the route (or the path). A reception side of the data signals counts the number of data signals received from the internal signal route (or the transmission path) and sets a reception counter value counted at a timing when the monitor signal is received into the received monitor signal.

### CROSS-REFERENCE TO RELATED APPLICATION

This application is based upon and claims the benefit of priority of the prior Japanese Patent Application No. 2015-186838, filed on Sep. 24, 2015, the entire contents of which are incorporated herein by reference.

### FIELD

The embodiments discussed herein are related to a transmission apparatus and a transmission systems.

### BACKGROUND

With spreading the Internet and mobile networks widely in recent years, the network traffic has rapidly increased.

Therefore, for example, expanding transmission capacity of a core network has been discussed, and research and development (R&D) of an OTN (Optical Transport Network) that provides the transmission capacity of 100 Gbps or more have progressed. Further, technologies of a packet-based network utilizing the Ethernet (registered trademark) technology and/or the Internet Protocol (IP) technology have also progressed.

### PATENT DOCUMENT LIST

JP 2014-165819 A

JP 2010-219802 A

WO 2007/010763 A1

JP 2010-16654 A.

There is a case where a monitor signal is periodically transmitted to a route through which a signal is transmitted or transferred in order to monitor a connectivity or reachability of a signal transmitted through a network or transmitted in a transmission apparatus.

For example, in a transmission side of a data signal, the number of transmitted data signals is counted by a transmission counter, and in a reception side, the number of received data signals is counted by a reception counter.

The reception counter value at the timing when the reception side receives the monitor signal is compared with the transmission counter value at the timing when the transmission side transmits a monitor signal. When there is not any difference between both of the counter values, it can be confirmed that a loss of the data signal does not occur.

Here, for example, on the reception side of the data signal, when the counter value of the reception counter is read after the reception of the monitor signal, the counter value may be updated before the reading of the counter value.

In this case, the read counter value is different from the counter value at the actual reception timing of the monitor signal, and therefore, error occurs. Thus, a monitor accuracy for the connectivity of a data signal decreases, and it results in decreasing a reliability of a connectivity monitor.

### SUMMARY

As one aspect, a transmission apparatus transmits and receives a data signal. The transmission apparatus may include a transmission counter, a transmission counter value setting unit, a reception counter, and a reception counter value setting unit. The transmission counter may count the number of the data signals transmitted to an internal signal route in the transmission apparatus. The transmission counter value setting unit may set a transmission counter value of the transmission counter in a monitor signal to be transmitted to the internal signal route. The counter value set in the monitor signal is counted at a timing when the monitor signal is transmitted to the internal signal route. The reception counter may count the number of the data signals received from the internal signal route. The reception counter value setting unit may set a reception counter value of the reception counter in the monitor signal. The reception counter value set in the monitor signal is counted at a timing when the monitor signal is received from the internal signal route.

Further, as another aspect, a transmission system may include a first transmission apparatus which transmits a data signal to a transmission path, and a second transmission apparatus which receives the data signal from the transmission path. The first transmission apparatus may include a transmission counter, and a transmission counter value setting unit. The transmission counter may count the number of the data signals transmitted to the transmission path. The transmission counter value setting unit may set a transmission counter value of the transmission counter in a monitor signal to be transmitted to the transmission path. The transmission counter value set in the monitor signal is counted at a timing when the monitor signal is transmitted to the transmission path. Meanwhile, the second transmission apparatus may include a reception counter, and a reception counter value setting unit. The reception counter may count the number of the data signals received from the transmission path. The reception counter value setting unit may set a reception counter value of the reception counter in the monitor signal. The reception counter value set in the monitor signal is counted at a timing when the monitor signal is received from the transmission path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration example of a communication system according to a first embodiment;

FIG. 2 is a block diagram illustrating a configuration example of the transmission apparatus depicted in FIG. 1;

FIG. 3 is a diagram illustrating a format example of an Ethernet frame according to the first embodiment;

FIG. 4 is a diagram illustrating an example of a method of connectivity monitor using a monitor packet according to the first embodiment;

FIG. 5 is a block diagram illustrating a configuration example of a monitor packet transmitter according to the first embodiment;

FIG. 6 is a block diagram illustrating a configuration example of a monitor packet receiver according to the first embodiment;

FIG. 7 is a diagram illustrating an operation example of the monitor packet transmitter depicted in FIG. 5;

FIG. 8 is a diagram illustrating an operation example of the monitor packet receiver depicted in FIG. 6;

FIGS. 9A to 9C are diagrams schematically illustrating format examples of the monitor packet;

FIG. 10 is a diagram illustrating a comparative example for FIG. 8; and

FIG. 11 is a block diagram illustrating a configuration example of a communication system according to a second embodiment.

### DESCRIPTION OF EMBODIMENTS

In the following, embodiments will be described with reference to the accompanying drawings. However, the embodiments described below are merely illustrative and are not intended to exclude various modifications and applications of techniques not described below. In addition, various exemplary embodiments described below may be appropriately combined to be performed. In the drawings used in the following embodiments, the portions denoted by the same reference numerals represent identical or similar portions unless otherwise specified.

### First Embodiment

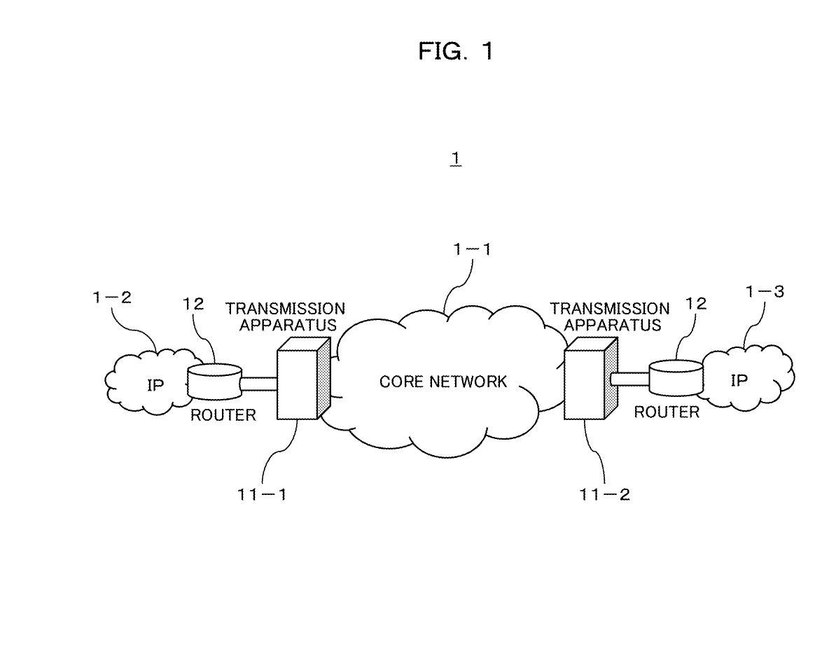

FIG. 1 is a block diagram illustrating a configuration example of a communication system according to a first embodiment. The communication system 1 illustrated in FIG. 1 (which may also be referred to as a “transmission system”) may include, for example, a first network 1-1, a second network 1-2, and a third network 1-3.

The first network 1-1 may be a core network. The core network 1-1 may be an OTN (Optical Transport Network). The signal to be transmitted through the core network 1-1 may be referred to as a “main signal” for the purpose of description. In the OTN 1-1, the “main signal” may be an “OTN frame”.

The second network 1-2 and the third network 1-3 may be tributary networks of the core network 1-1. One or both of the tributary networks 1-2 and 1-3 may be the Ethernet or an IP network that supports the IP.

A signal to be transmitted through the tributary networks 1-2 and 1-3 may be referred to as a “tributary signal” for the purpose of description. In the Ethernet 1-2 or 1-3, the “tributary signal” may be an “Ethernet frame”.

The core network 1-1 may be provided with transmission apparatuses 11-1 and 11-2. The “transmission apparatus” may also be referred to as a “communication apparatus”. An example of the transmission apparatuses 11-1 and 11-2 may be a packet optical networking platform (P-ONP) or a ROADM (reconfigurable optical add-drop multiplexer). When the transmission apparatuses 11-1 and 11-2 do not have to be distinguished with each other, they may be abbreviated as a “transmission apparatus 11”.

Each of the tributary networks 1-2 and 1-3 may be communicatively connected to the transmission apparatus 11 through a router 12. One or more other communication apparatuses may be provided between the router 12 and the transmission apparatus 11. The “other communication apparatus” may be a provider edge router, for example.

The transmission apparatus 11 may convert a tributary signal received from the tributary network 1-2 or 1-3 through the router 12 into a main signal available for transmission in the core network 1-1.

Such “conversion” may be referred to as a “protocol conversion”. The protocol conversion from the tributary signal to the main signal may include a “mapping”. For example, in the transmission apparatus 11, the Ethernet frame that is an example of the tributary signal may be “mapped” into the tributary slots (TS) of the OTN frame that is an example of the main signal. The TS is an example of a time-division slot in the OTN frame. Therefore, the OTN 1-1 may be considered as an example of a time division multiplexing (TDM) network.

Further, each transmission apparatus 11 may receive the main signal transmitted through the core network 1-1 to convert the received main signal into the tributary signal available for transmission in the tributary network 1-2 or 1-3.

Such “conversion” may also be referred to as a “protocol conversion”. The protocol conversion from the main signal to the tributary signal may include a “demapping”. For example, in the transmission apparatus 11, the tributary signal mapped in the TS of the OTN frame may be “demapped”. The demapped tributary signal may be transmitted to the tributary network 1-2 or 1-3 corresponding to a destination of the tributary signal.

Through the protocol conversion in the transmission apparatus 11 as described above, it is possible to transmit signals transparently through the core network 1-1 between the tributary networks 1-2 and 1-3, for example.

In other words, in the transmission apparatus 11, the differences between the protocols of various signals transmitted between the tributary networks 1-2 and 1-3 can be absorbed. Therefore, it is facilitated to increase in capacity (in other words, increase in transmission rate) of the signal transmitted through the core network 1-1 and to increase in redundancy of the transmission path.

In FIG. 1, two of the transmission apparatuses 11 are illustrated, however, three or more transmission apparatuses 11 may be provided in the core network 1-1. Further, the signal to be transmitted and received in the transmission apparatus 11 may be a frame signal such as the aforementioned OTN frame, Ethernet frame, and IP frame, and may be a packet signal.

The frame signal and the packet signal may be abbreviated as the “frame” and the “packet”, respectively. Hereinafter, the “frame” and the “packet” may be treated as the terms substitutable for each other. A server apparatus available to transfer a packet may correspond to the transmission apparatus 11.

When a packet-based data such as the Ethernet frames and the IP frames are transferred in a time-division multiplexing (TDM) network such as the OTN, technologies called a GFP-F and/or a GFP-T are applicable. The “GFP” is an abbreviation of “Generic Frame Procedure”.

The “GFP-F” is a protocol example to map each packet into a single GFP frame, for example. The “GFP-T” is a protocol example to perform a bit-sampling on input data without regard for units of packet to map the bit-sampled data into the GFP frame.

(Configuration Example of Transmission Apparatus)

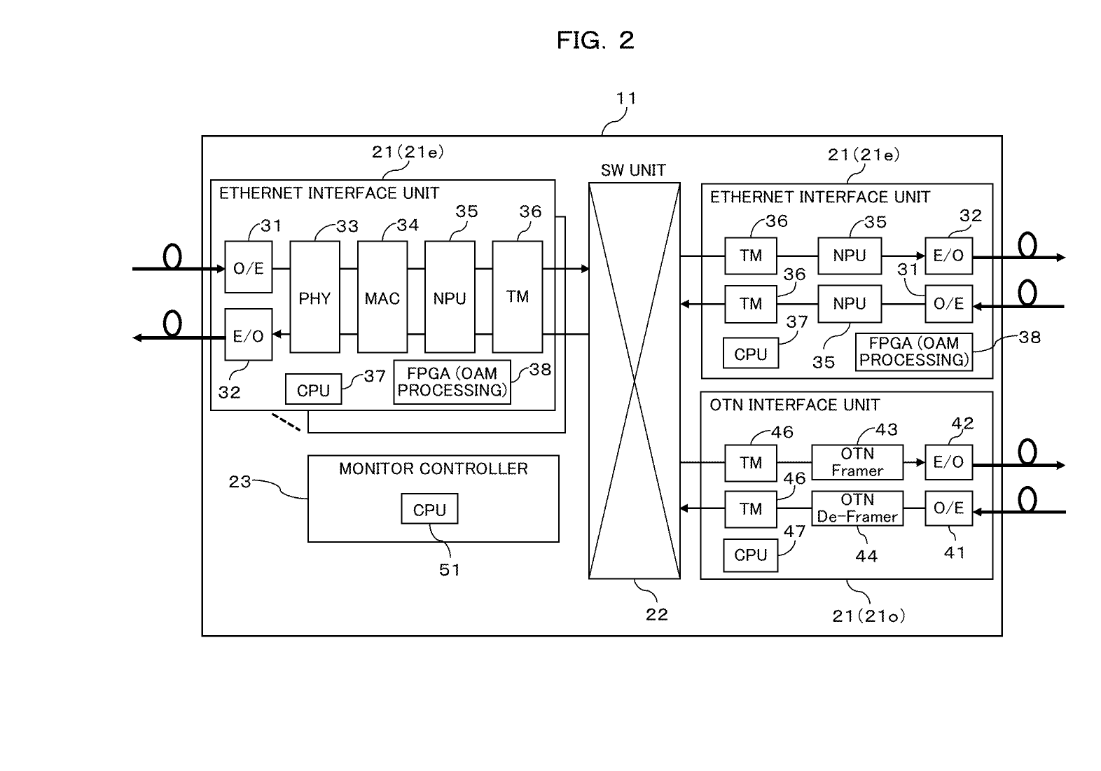

A configuration example of the transmission apparatus 11 is illustrated in FIG. 2. The transmission apparatus 11 illustrated in FIG. 2 may include, for example, a plurality of interface units 21, a switch unit 22, and a monitor controller 23. The number of interface units 21 may be dependent on the number of possible networks to be connected to the transmission apparatus 11. The above elements 21 to 23 may be referred to as “cards” 21 to 23, respectively, for the purpose of description. The monitor controller 23 may simply be referred to as a “monitor 23”.

The plurality of interface units 21 may include an Ethernet interface unit 21 to be connected to the Ethernet, and an OTN interface unit 21 to be connected to the OTN, for example.

The Ethernet interface unit 21 may be expressed as an “Ethernet interface unit 21e” with “e” attached to the reference numeral 21. The OTN interface unit 21 may be expressed as an “OTN interface unit 21o” with “o” attached to the reference numeral 21.

The switch (SW) 22 may be connected to any of the interface units 21 to form internal (or local) signal routes between any of the interface units 21.

The monitor controller 23 may monitor and control the overall operation of the transmission apparatus 11. Therefore, the monitor controller 23 may be communicatively connected to the interface units 21 and the switch unit 22 to monitor and control the operation of the interface units 21 and the switch unit 22.

The monitor and the control by the monitor controller 23 may be achieved by using a CPU (Central Processing Unit) 51, for example. The “CPU” is an example of a computing device having an arithmetic capacity, and may be referred to as a processor circuit or a processor device. The processor circuit is not limited to a CPU, and may be a DSP (Digital Signal Processor) and the like.

The Ethernet interface unit 21e illustrated in the upper left corner of the transmission apparatus 11 depicted in FIG. 2 may include, for example, an optic-electric converter (O/E) 31, an electric-optic converter (E/O) 32, a physical (PHY) layer processor 33, and a MAC layer processor 34. The “MAC” is an abbreviation of “Media Access Control”.

Further, the Ethernet interface unit 21e may include, for example, a network processor unit (NPU) 35, a traffic manager (TM) 36, a CPU 37, and an OAM processor 38. The “OAM” is an abbreviation of “Operations, Administration, and Maintenance”.

The O/E 31 may convert an optical signal received from the Ethernet 1-2 or 1-3 into an electrical signal. The O/E 31 may be provided with one or more input ports (which may be referred to as “reception ports”).

The E/O 32 may convert an electrical signal to be transmitted to the Ethernet 1-2 or 1-3 into an optical signal. The E/O 32 may be provided with one or more output ports (which may be referred to as “transmission ports”).

Each of the O/E 31 and the E/O 32 may be referred to as an “optical module”. Alternatively, the O/E 31 and the E/O 32 may be included in a single “optical module”.

The physical layer processor 33 may perform physical layer processing on a reception Ethernet frame converted into an electric signal by the O/E 31 and on a transmission Ethernet frame received from the MAC layer processor 34. The physical layer processing may include a frame synchronization processing, a header termination processing of the reception Ethernet frame, a header addition processing of the transmission Ethernet frame, and the like.

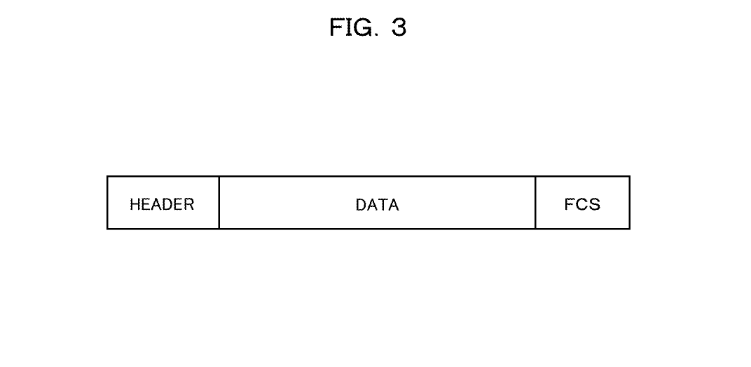

An example format of the Ethernet frame is illustrated in FIG. 3. The Ethernet frame may include a header field, a data field, and a frame check sequence (FCS) field. The “data field” may be referred to as a “payload field”.

Frame synchronization information called a preamble, transmission destination address information, transmission source address information, and the like may be set in the header field. The address information may be a MAC address.

A data body may be set in the payload field. An FCS for error detection of the Ethernet frame may be set in the FCS field. A CRC (Cyclic Redundancy Check) code may be used for the FCS.

With reference back to FIG. 2, the MAC layer processor 34 may perform MAC layer processing on a reception Ethernet frame being subjected to the physical layer processing by the physical layer processor 33 and on a transmission Ethernet frame received from the NPU 35.

The NPU 35 may process a reception packet being subjected to the MAC layer processing in the MAC layer processor 34 and a transmission packet input from the TM 36. For example, the NPU 35 may perform a destination resolution and a packet distribution according to a destination of an input packet, and an addition, deletion, or changes of information for the input packet. Further, the NPU 35 may collect statistical information about the packet. The statistical information about the packet may be a counter value of the number of transmissions and/or the number of receptions of the packets per ports.

The TM 36 may control a data rate within the transmission apparatus 11 of the transmission packets to the Ethernet 1-2 or 1-3 and the reception packets from the Ethernet 1-2 or 1-3. The statistical information about the packet may be collected also in the TM 36 in the same manner as in the NPU 35.

The CPU 37 may monitor and control an operation of the Ethernet interface unit 21e. The CPU 37 may be replaced with a DSP.

The OAM processor 38 may perform processing related to the OAM of the transmission apparatus 11 (which may be referred to as “OAM processing”). The OAM processing may include a generation of the packet for the OAM processing (which may be referred to as an “OAM packet” or “monitor packet”).

The monitor packet may be transferred in the same route as an internal signal route through which a packet including user data (which may be referred to as “user packet”) is transmitted within the transmission apparatus 11. By transmitting the monitor packet in the same route as the route of the user packet, it is possible to check and confirm whether an abnormality exists in the user traffic (which may be referred to as a “data plane”) or not.

Therefore, the monitor packet generated by the OAM processor 38 may be inserted into the user traffic in the internal signal route at the NPU 35 and the TM 36. The monitor packet may be inserted into the internal signal route periodically or non-periodically. The user packet is an example of a data signal, and the monitor packet is an example of a monitor signal.

The monitor packet inserted into the user traffic may be extracted from the user traffic in another interface unit 21 different from the interface unit 21 in which the monitor packet is inserted.

The OAM processor 38 may be implemented with an FPGA (Field-Programmable Gate Array). The FPGA is an example of a programmable logic device (PLD). The OAM processor 38 may be implemented by using an IC (Integrated Circuit), an LSI (Large-Scale Integration), or an ASIC (Application Specific Integrated Circuit), instead of or in addition to the FPGA and the PLD.

The OAM processing performed by the OAM processor 38 may be controlled by the CPU 37. The CPU 37 may be controlled by the monitor controller 23. For example, the OAM processor 38 may generate a monitor packet in response to a reception of an instruction from the monitor controller 23 through the CPU 37.

A part or all of the processing by the OAM processor 38 may be performed by the CPU 37. For example, the CPU 37 may generate the monitor packet.

As illustrated in the Ethernet interface unit 21e in the upper right corner of the transmission apparatus 11 depicted in FIG. 2, functions of the physical layer processor 33 and the MAC layer processor 34 may be integrated into the NPU 35. Further, each of the NPU 35 and the TM 36 may be separately provided for the transmission processing and the reception processing.

Meanwhile, the OTN interface unit 210 illustrated in the lower right corner of the transmission apparatus 11 depicted in FIG. 2 may include, for example, an O/E 41, an E/O 42, an OTN framer 43, an OTN deframer 44, a traffic manager (TM) 46, and a CPU 47.

The O/E 41 may convert an optical signal received from the OTN 1-1 (for example, OTN frame) into an electrical signal. The O/E 41 may be provided with one or more reception ports.

The E/O 42 may convert an electrical signal (for example, an OTN frame) to be transmitted to the OTN 1-1 into an optical signal. The E/O 42 may be provided with one or more reception ports.

Each of the O/E 41 and the E/O 42 may be referred to as an “optical module”. Alternatively, The O/E 41 and the E/O 42 may be included in a single “optical module”.

The OTN framer 43 may map a packet input from the switch unit 22 through the traffic manager 46 into an OTN frame.

The OTN deframer 44 may extract a packet mapped in an OTN frame input from the O/E 41.

Statistical information of the packets may be collected in one or both of the OTN framer 43 and the OTN deframer 44.

The TM 46 may control a data rate within the transmission apparatus 11 of a transmission packet to be mapped into an OTN frame and a reception packet demapped from an OTN frame.

Statistical information of the packets may also be collected in the TM 46 as in the OTN framer 43 and the OTN deframer 44.

The CPU 47 may monitor and control an operation of the OTN interface unit 21o. The CPU 47 may be replaced with a DSP. The monitor packet may be generated by the CPU 47.

The monitor packet generated by the CPU 47 may be inserted into a user traffic flowing toward the OTN framer 43 from the switch unit 22 and/or into a user traffic flowing toward the switch unit 22 from the OTN deframer 44.

Any one of the interface units 21 collects the statistical information on the user packets transmitted between the monitor packets, which are transferred within the transmission apparatus 11 in the same internal signal route as that of the user packets. The monitor controller 23 confirms the collection result.

Therefore, the monitor controller 23 is possible to detect which internal signal route passing through any one or more of the interface unit 21 has an abnormality. The detection of the abnormality may be referred to as a “connectivity monitor” or an “abnormality monitor”. For example, the monitor controller 23 is possible to detect a packet loss occurred in any one or more of internal signal routes.

(An Example of Method of Connectivity Monitor)

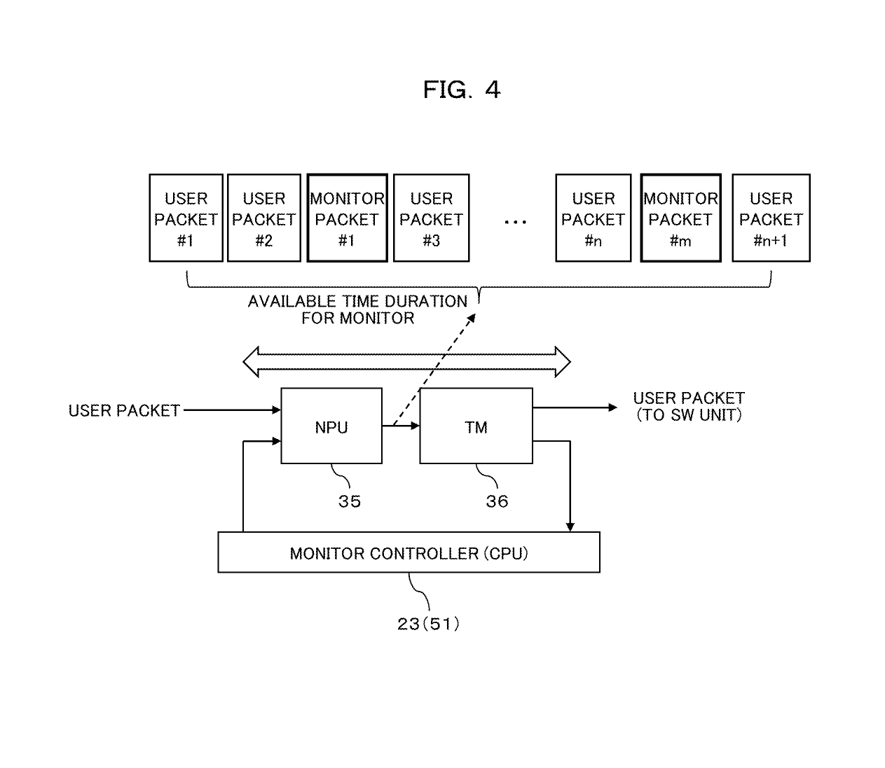

FIG. 4 illustrates an example of a method of connectivity monitor using a monitor packet. For example, the monitor controller 23 instructs an NPU 35 in any one of the interface units 21 to generate and insert a monitor packet. For example, the NPU 35 generates the monitor packet in response to the instruction and inserts the monitor packet into the user traffic periodically.

In the example in FIG. 4, m (m is an integer that satisfies 1≦m<n) monitor packets #1 to #m are inserted into the user packets #1 to #n+1 (n is a natural number).

The user packet and the monitor packet transmitted from the NPU 35 are received by the TM 36. The TM 36 may be a TM 36 provided in an interface unit 21 which includes the transmission source NPU 35 of the monitor packet, and may be a TM 36 provided in an interface unit 21 different from the interface unit 21 which includes the transmission source NPU 35 of the monitor packet.

Here, the NPU 35 counts the number of the transmitted user packets as an example of the statistical information. Meanwhile, the TM 36 counts the number of the received user packets as another example of the statistical information.

When the counter value of a transmission user packet at a timing when the monitor packet #x (x is any one of 1 to m) is transmitted and the counter value of a reception user packet at a timing when the TM 36 receives the monitor packet #x match, the packet loss does not occur.

In other words, it is possible to confirm whether packet loss occurs in the internal signal route between the NPU 35 and the TM 36. The monitor controller 23 may confirm the counter value, for example.

FIG. 4 assumes a monitor example of an internal signal route in a single Ethernet interface unit 21e, or an internal signal route between different Ethernet interface units 21e. However, it is also possible to monitor an internal signal route in a single OTN interface unit 21o, an internal signal route between different OTN interface units 21o, or an internal signal route between an Ethernet interface unit 21e and an OTN interface unit 210 in the same manner.

For example, in the example in FIG. 4, the NPU 35 that is a transmission source of the monitor packet may be read as the TM 46 or the OTN deframer 44 in the OTN interface unit 21o. Further, in the example in FIG. 4, the TM 36 that receives a monitor packet may be read as the TM 46 or the OTN framer 43 in the OTN interface unit 21o.

By the way, the transmission interval of the monitor packets affects a period available to detect an abnormality. For example, when the transmission interval of the monitor packets is increased, an accuracy or sensitivity of detection of the packet loss that occurs temporarily or intermittently would be decreased.

The temporary or intermittent packet loss may occur due to an unstable operation of a unit or device positioned on the internal signal routes. The unit or device positioned on the internal signal route may correspond to the physical layer processor 33, the MAC layer processor 34, the NPU 35, the TM 36, the TM 46, the switch unit 22, the OTN framer 43, or the OTN deframer 44, for example.

Meanwhile, when the transmission interval of the monitor packets is increased to improve the accuracy or sensitivity of the detection for the temporary or intermittent packet loss, a band available for the user traffic would be consumed and squeezed by the transmission of the monitor packets.

Therefore, it is preferable to improve the accuracy or sensitivity of the detection for the temporary or intermittent packet loss, even though the transmission interval of the monitor packets is increased (in other words, even though the transmission rate of the monitor packet is decreased) for not squeezing the band available for the user traffic.

In the following, a concrete example of a monitor method possible to improve the accuracy or sensitivity of detection for the temporary or intermittent packet loss even when a low-rate monitor packet is used will be described.

(Configuration Example of Packet Transmitter)

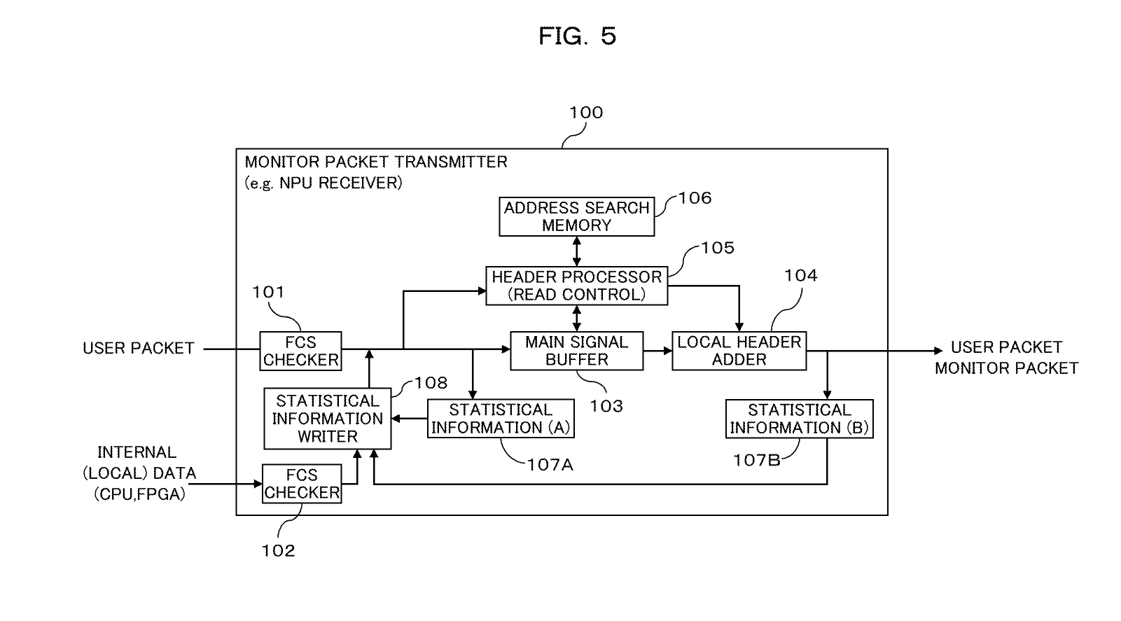

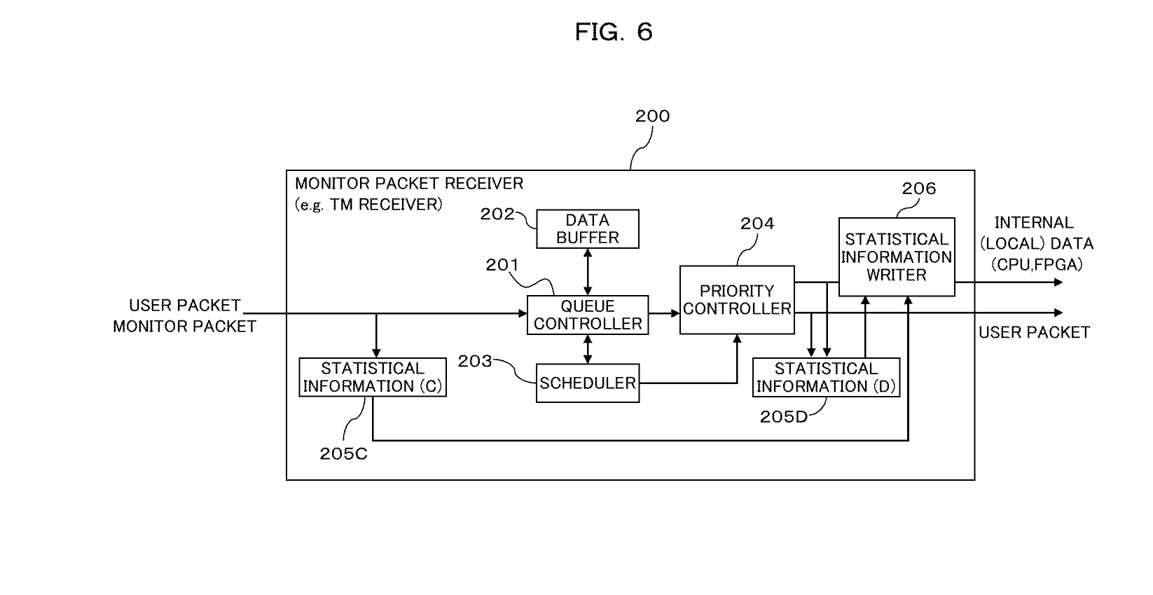

FIG. 5 is a block diagram illustrating a configuration example of a packet transmitter according to the first embodiment, and FIG. 6 is a block diagram illustrating a configuration example of a packet receiver according to the first embodiment.

The packet transmitter 100 depicted in FIG. 5 transmits a user packet and a monitor packet to the internal signal route. In other words, the packet transmitter 100 is a transmission source of the monitor packet, and may be referred to as a “monitor packet transmitter 100” for the purpose of description.

The packet receiver 200 depicted in FIG. 6 receives the user packet and the monitor packet through the internal signal route. In other words, the packet receiver 200 receives the monitor packet transmitted by the monitor packet transmitter 100 to the internal signal route. Therefore, the packet receiver 200 may be referred to as a “monitor packet receiver 200” for the purpose of description.

The monitor packet transmitter 100 may be provided in the NPU 35 or the TM 36 of the Ethernet interface unit 21e depicted in FIG. 2, or may be provided in the OTN deframer 44 or the TM 46 of the OTN interface unit 21o.

Meanwhile, the monitor packet receiver 200 may be provided in the TM 36 or the NPU 35 of the Ethernet interface unit 21e depicted in FIG. 2, or may be provided in the TM 46 or the OTN framer 43 of the OTN interface unit 21o.

Further, the monitor packet transmitter 100 and the monitor packet receiver 200 may be provided in a single interface unit 21, or may be distributed in different interface units 21.

The monitor packet transmitter 100 may include FCS checkers 101 and 102, a main signal buffer 103, a local header adder 104, a header processor 105, and an address search memory 106 as depicted in FIG. 5. Further, the monitor packet transmitter 100 may include statistical information collectors 107A and 107B, and a statistical information writer 108.

The FCS checker 101 may check an FCS of an input user packet. As a result of FCS check, the user packet for which any errors are not detected may be buffered in the main signal buffer 103, for example. The user packet for which an error is detected may be discarded in the FCS checker 101.

The FCS checker 102 may check an FCS of an input control data. The control data may be an instruction of the generation and the insertion of the monitor packet. The transmission source of the control data may be any one of the CPU 51, the CPU 37, the CPU 47, and the OAM processor 38, for example.

As a result of the FCS check of the control data, the control data for which any errors are not detected may be given to the statistical information writer 108. The control data for which an error is detected may be discarded in the FCS checker 102.

The main signal buffer 103 is an example of a storage unit to store input packets temporarily. The input packet input to the main signal buffer 103 may include a user packet which is an example of the main signal and a monitor packet inserted by the statistical information writer 108 between the user packets.

The writing and reading of the packet for the main signal buffer 103 may be performed by the header processor 105.

The local header adder 104 may add header information indicative of the internal signal route in the transmission apparatus 11 (which may be referred to as “local header information”) to the packet read from the main signal buffer 103. The switch unit 22 may be switched based on the local header information.

The local header information may be generated in the header processor 105. For example, the header processor 105 may perform, based on the address information stored in the address search memory 106, a destination resolution of a packet and/or a generation of the local header information corresponding to the destination of the packet.

The statistical information collector 107A may collect the statistical information on the transmission user packets input into the main signal buffer 103. The statistical information may include a counter value of the number of transmission user packets.

The statistical information collector 107B may collect the statistical information on the transmission user packets output from the local header adder 104, in other words, the statistical information on the output user packets of the packet transmitter 100. The statistical information may include a counter value of the number of transmission user packets.

When the statistical information collectors 107A and 107B do not need to be distinguished with each other, each of them may be referred to as a “statistical information collector 107” with omitting the signs A and B.

Further, the statistical information and the counter value obtained by the statistical information collector 107A may be expressed as the “statistical information (A)” and the “counter value (A)”, respectively. Similarly, the statistical information and the counter value obtained by the statistical information collector 107B may be expressed as the “statistical information (B)” and the “counter value (B)”, respectively.

The counter value (A or B) collected by the packet transmitter 100 may be referred to as a “transmission counter value” for the purpose of description. Therefore, the statistical information collector 107 may be considered as an example of a “transmission counter” which counts the number of transmission user packets.

The statistical information writer 108 may generate a monitor packet in which one or both of the statistical information (A) and the statistical information (B) are written to insert the monitor packet between the user packets to be buffered in the main signal buffer 103.

The statistical information writer 108 is an example of a “transmission counter value setting unit” which sets the transmission counter value, which is counted at a timing when the monitor packet transmitted to the internal signal route, into the monitor packet. The setting of the value may be paraphrased into a “recording of the value”.

(Configuration Example of Packet Receiver)

Meanwhile, the monitor packet receiver 200 depicted in FIG. 6 may include, for example, a queue controller 201, a data buffer 202, a scheduler 203, a priority controller 204, statistical information collectors 205C and 205D, and a statistical information writer 206.

The queue controller 201 may store input packets in the data buffer 202 temporarily, and read the packets from the data buffer 202 in response to a control from the scheduler 203 to output the read packets to the priority controller 204.

The scheduler 203 may control the order of the packets read by the queue controller 201. Further, the scheduler 203 may control the priority controller 204 to control a preferential output order of the packets to be output from the priority controller 204.

The priority controller 204 may output, in response to a control from the scheduler 203, the packets input from the queue controller 201 in the output order according to a priority. The control based on the priority may be a QoS (Quality of Service) control and a band control.

The statistical information collector 205C may collect the statistical information on the reception user packets input to the queue controller 201. The statistical information may include a counter value of the number of reception user packets.

The statistical information collector 205D may collect the statistical information on the reception user packets output from the priority controller 204, in other words, on the output user packets of the packet receiver 200. The statistical information may include a counter value of the number of reception user packets.

When the statistical information collectors 205C and 205D do not need to be distinguished with each other, each of them may be referred to as a “statistical information collector 205” with omitting the signs C and D.

Further, the statistical information and the counter value obtained by the statistical information collector 205C may be expressed as the “statistical information (C)” and the “counter value (C)”, respectively. Similarly, the statistical information and the counter value obtained by the statistical information collector 205D may be expressed as the “statistical information (D)” and the “counter value (D)”, respectively.

The counter value (C or D) collected by the packet receiver 200 may be referred to as a “reception counter value” for the purpose of description. Therefore, the statistical information collector 205 may be considered as an example of a “reception counter” which counts the number of reception user packets.

The statistical information writer 206 may detect the monitor packets inserted by the packet transmitter 100 between user packets to write one or both of the statistical information (C) and the statistical information (D) into the monitor packets.

The statistical information writer 206 is an example of a “reception counter value setting unit” which sets the reception counter value, which is counted at a timing when the monitor packet is received from the internal signal route, into the monitor packet.

Here, one or both of the statistical information (A) and (B) have already been written into the monitor packet input to the packet receiver 200 in the packet transmitter 100. Therefore, one or both of the statistical information (C) and (D) are additionally written into the monitor packet by the statistical information writer 206.

With a comparison between the transmission counter value (A) and the reception counter value (C), it is possible to detect a packet loss in the internal signal route from the input side of the main signal buffer 103 in the packet transmitter 100 to the input side of the queue controller 201 in the packet receiver 200. For example, when A>C, it is possible to confirm that the packet loss has been occurred in that internal signal route.

Further, with a comparison between the transmission counter value (A) and the reception counter value (D), it is possible to detect a packet loss in the internal signal route from the input side of the main signal buffer 103 in the packet transmitter 100 to the output side of the priority controller 204 in the packet receiver 200. For example, when A>D, it is possible to confirm that the packet loss has been occurred in that internal signal route.

Furthermore, with a comparison between the transmission counter value (B) and the reception counter value (C), it is possible to detect a packet loss in the internal signal route from the output side of the local header adder 104 in the packet transmitter 100 to the input side of the queue controller 201 in the packet receiver 200. For example, when B>C, it is possible to confirm that the packet loss has been occurred in that internal signal route.

Furthermore, with a comparison between the transmission counter value (B) and the reception counter value (D), it is possible to detect a packet loss in the internal signal route from the output side of the local header adder 104 in the packet transmitter 100 to the output side of the priority controller 204 in the packet receiver 200. For example, when B>D, it is possible to confirm that the packet loss has been occurred in that internal signal route.

Thus, with a comparison between the statistical information included in the monitor packet in the packet transmitter 100 and the statistical information included in the monitor packet in the packet receiver 200, it is possible to monitor a connectivity of the internal route identical to a route in which the user packets are transferred.

The comparison of the statistical information described above may be performed in the CPU 51 of the monitor controller 23. Therefore, the monitor packet in which the statistical information is written in the statistical information writer 206 may be transmitted (which may be referred to as “notified”) to the CPU 51 of the monitor controller 23.

The notification of the monitor packet from the statistical information writer 206 to the CPU 51 may be performed through the CPU 37 and the OAM processor 38 for the Ethernet interface unit 21e, and may be performed through the CPU 47 for the OTN interface unit 21o.

In each of the packet transmitter 100 and the packet receiver 200, a route to be monitored for the connectivity can be changed by changing points (which may be referred to as “collection points” or “monitor points”) to collect the statistical information.

In other words, the number of statistical information collectors 107 and statistical information collectors 205 provided in the interface unit 21 may be increased or decreased depending on the number of monitor points in the transmission apparatus 11.

### Operation Example

In the following, an operation example of the method of connectivity monitor using the monitor packet in the present embodiment will be described.

As a non-limiting example, an example of writing the statistical information (A) into a monitor packet in the packet transmitter 100 and an example of writing the statistical information (D) into the monitor packet in the packet receiver 200 will be described.

In other words, as depicted in FIGS. 5 and 6, an example of monitoring the connectivity of the internal signal route from the output side of the local header adder 104 in the packet transmitter 100 to the output side of the priority controller 204 in the packet receiver 200 will be described.

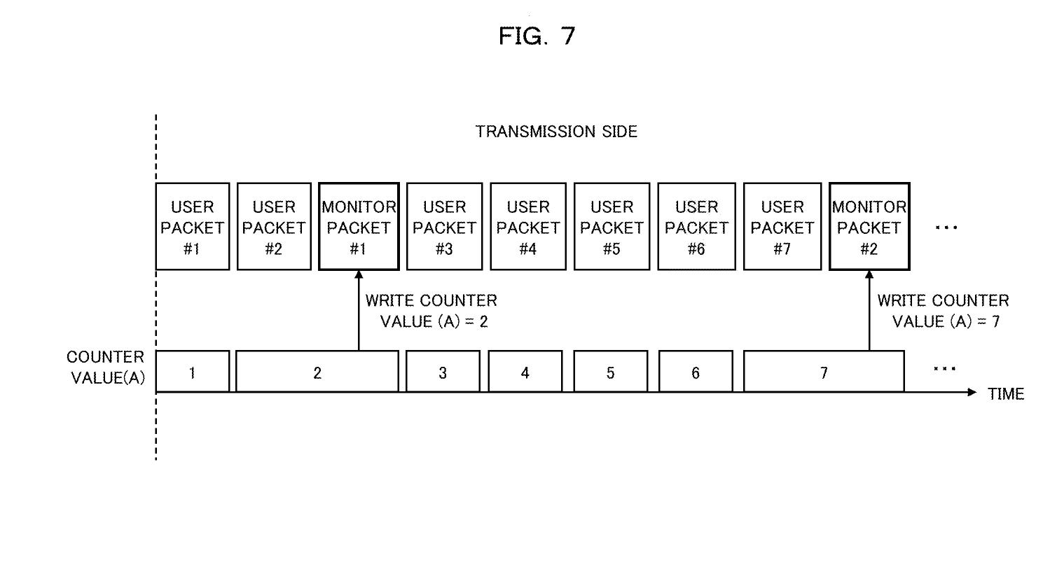

As schematically depicted in FIG. 7, the packet transmitter 100 transmits user packets #1 to #7, and after the transmission of the user packets #1 and #2, transmits a monitor packet #1. Further, after the transmission of the user packets #3 to #7, the packet transmitter 100 transmits another monitor packet #2.

Here, in the packet transmitter 100, the monitor packet generated, for example, by the CPU 37, the OAM processor 38, or the CPU 47 is input into the statistical information writer 108 in response to a control from the monitor controller 23.

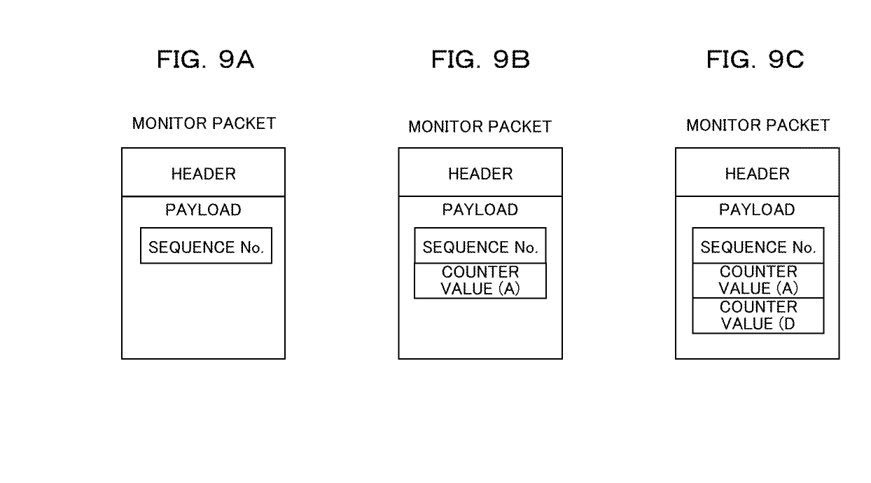

A format example of the monitor packet is schematically illustrated in FIG. 9A. As illustrated in FIG. 9A, the monitor packet may include a header field and a payload field. A sequence number may be set in the payload field.

The sequence number may be used to monitor a loss of the monitor packet itself and to check a reversal of the packet order. For example, when there is not continuity in the sequence numbers of a plurality of monitor packets, it is possible to detect that a loss of a monitor packet has been occurred. Further, when a magnitude relation of the sequence numbers of the plurality of monitor packets is reversed, it is possible to detect that a reversal in the sequence of the monitor packets has been occurred. The aforementioned monitor of the connectivity may be performed based on the monitor packet sequence numbers.

As schematically illustrated in FIG. 9B, the statistical information writer 108 writes the transmission counter value (A) counted in the statistical information collector 107A into, for example, the payload field of the monitor packet to insert the monitor packet into the user traffic flowing to the main signal buffer 103.

For example, in the example in FIG. 7, two user packets #1 and #2 are already transmitted at a transmission timing of the monitor packet #1, and therefore, the transmission counter value (A)=2 is written into the payload field of the monitor packet #1.

Similarly, seven user packets #1 to #7 are already transmitted at a transmission timing of the monitor packet #2, and therefore, the transmission counter value (A)=7 is written into the payload field of the monitor packet #2.

In other words, the monitor packet #1 is transmitted subsequent to the user packet (#2 or #7) which is counted last among the user packets counted in the statistical information collector 107A. The “writing” of the counter value into the monitor packet may be referred to as “recording”.

The monitor packet recorded the transmission counter value (A) therein is transferred in the internal signal route same as the route for the user traffic and is input to the packet receiver 200.

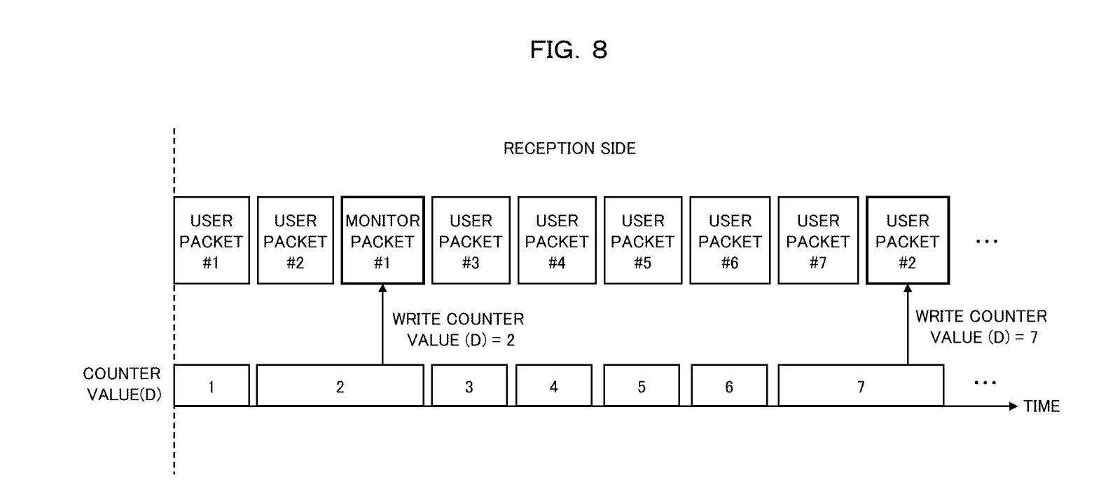

As illustrated in FIG. 8, when a packet loss does not occur in the internal signal route, the packet receiver 200 receives the user packets #1 to #7 and the monitor packets #1 and #2 transmitted by the packet transmitter 100 in the transmission order depicted in FIG. 7.

Here, when the monitor packet #1 is received in the packet receiver 200, the reception counter value (D), which is counted in the statistical information collector 205D before the monitor packet #1 is received, is recorded into the monitor packet #1 by the statistical information writer 206.

In the example in FIG. 8, the reception counter value (D)=2 is written into the payload field of the reception monitor packet #1 as illustrated in FIG. 9C. Therefore, the transmission counter value (A)=2 and the reception counter value (D)=2 are recorded in the monitor packet #1.

Similarly, when the monitor packet #2 is received in the packet receiver 200, the reception counter value (D)=7, which is counted in the statistical information collector 205D before the monitor packet #2 is received, is recorded into the monitor packet #2 by the statistical information writer 206.

The statistical information writer 206 transmits the monitor packet #1 in which the transmission counter value (A) and the reception counter value (D) are recorded to the CPU 51 of the monitor controller 23 through the CPU 37, the OAM processor 38, or the CPU 47, for example.

The CPU 51 compares between the transmission counter value (A) and the reception counter value (D) which are recorded in the received monitor packet #1. When there is no difference between the transmission counter value (A) and the reception counter value (D), it is confirmed that a packet loss does not occur, and when there is a difference (for example, A>D), it is confirmed that a packet loss occurs.

In this way, By recoding the transmission counter value and the reception counter value into the monitor packet and notifying the CPU 51 of the counter values, the CPU 51 does not need to access the statistical information collectors 205 and 207 to read out each of the counter values.

For example, in a case where the statistical information collectors 107 and 205 are configured by hardware circuits each having a register for the counter values, the CPU 51 of the monitor controller 23 can read out the counter values by accessing the corresponding register.

However, in this case, a time lag due to the access to the register by the CPU 51 occurs. In other words, a time lag dependent on a processing time (which may be referred to as “CPU processing time”) for the CPU 51 to obtain the counter values occurs.

The transmission and reception processing of packets is continued in the interface unit 21 even during the time lag. Therefore, the counter value in the register of the hardware circuit continues to be updated. Thus, the counter value accessed and read by the CPU 51 would be different from the counter value at the transmission timing and the reception timing of the monitor packet. Therefore, an error of counter value may occur.

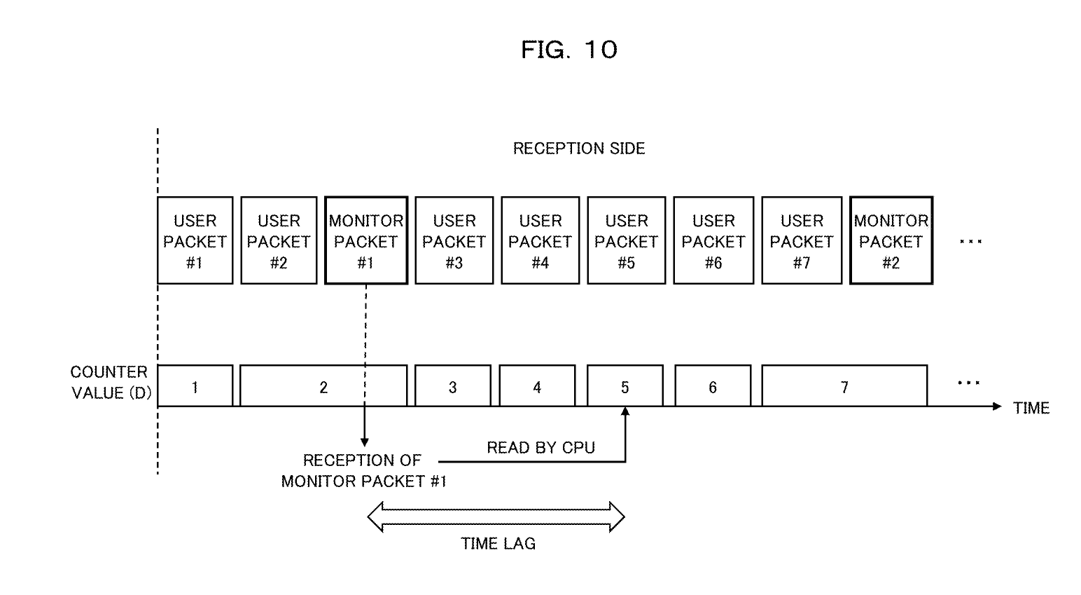

For example, descriptions will be made with focusing on the reception timing of the monitor packet. As schematically illustrated in FIG. 10, the reception counter value at the reception timing of the monitor packet #1 is “2”. However, due to the time lag caused by accessing the register, the reception counter value actually read by the CPU 51 at a timing of the accessing may be updated to “5”.

Thus, when an error occurs in the reception counter value read by the CPU 51, the CPU is unavailable to detect an accurate difference between the transmission counter value and the reception counter value. Therefore, the reliability of packet loss monitor is deteriorated.

In contrast, according to the embodiment described above, since the counter value at each of the timings of the transmission and reception of the monitor packet is recorded into the monitor packet in the interface unit 21, the CPU 51 is notified an accurate counter value at each timings of the transmission and reception of the monitor packet.

Therefore, it is possible to eliminate the CPU processing time caused by the register access to obtain the counter value, and to suppress the error in the counter value obtained by the CPU 51 due to the time lag dependent on the CPU processing time. Hence, the accuracy and reliability of packet loss monitor can be improved.

Further, even when the transmission interval of the monitor packets is increased, monitoring the number of packets of the user traffic between the monitor packets is still available.

Therefore, even though the transmission rate of the monitor packet is set to a low rate which would not squeeze a band available for the user traffic, it is available to achieve a packet loss monitor with high-accuracy and high-reliability.

In other words, it is possible to improve an accuracy and reliability of the packet loss monitor while minimizing an impact on the user traffic.

### Second Embodiment

The method of connectivity monitor in the first embodiment described above is not limited to the monitor for the packet internal signal route inside the transmission apparatus 11, and is applicable to a connectivity monitor for a transmission path between the transmission apparatuses 11-1 and 11-2 (see FIG. 1).

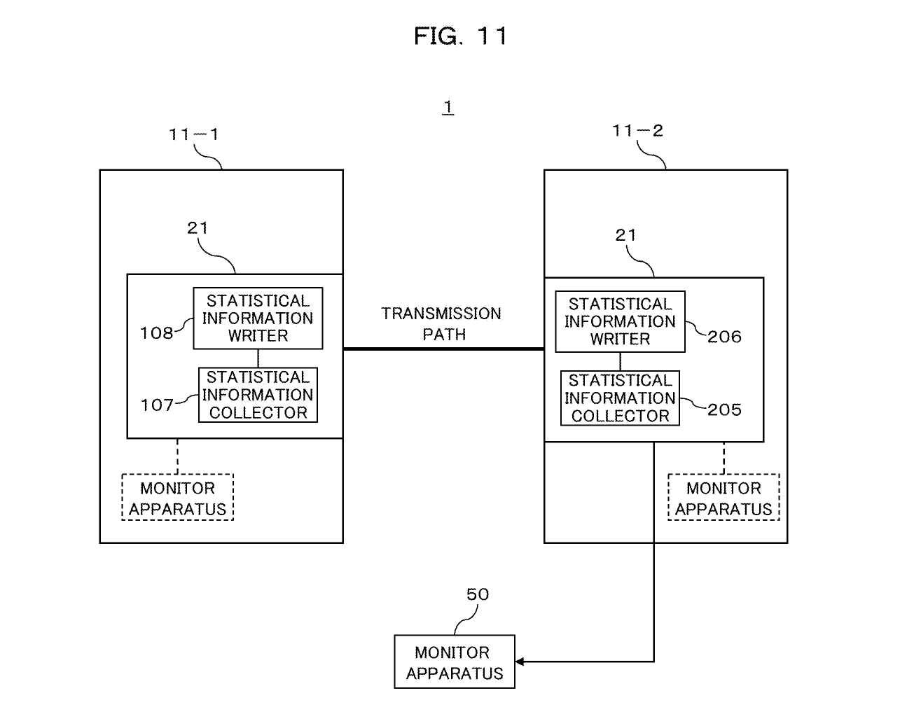

For example, as illustrated in FIG. 11, a statistical information collector 107 and a statistical information writer 108 are provided in the transmission interface unit 21 in the first transmission apparatus 11-1. Further, a statistical information collector 205 and a statistical information writer 206 are provided in the reception interface unit 21 in the second transmission apparatus 11-2.

Thus, in the first transmission apparatus 11-1, the transmission counter value at the transmission timing of the monitor packet is recorded into the monitor packet to be transmitted to the transmission path. In the second transmission apparatus 11-2, the reception counter value at the timing of receiving the monitor packet is recorded into the monitor packet received from the transmission path.

The monitor packet in which the transmission counter value and the reception counter value are recorded may be transmitted to the monitor apparatus 50. The monitor apparatus 50 may be provided outside the transmission apparatuses 11-1 and 11-2 as illustrated in FIG. 11, or may be provided in any one of the transmission apparatuses 11-1 and 11-2.

The monitor apparatus 50 may include a function corresponding to the aforementioned monitor controller 23, for example, and is possible to monitor the presence or absence of a packet loss accurately, based on the counter value recorded in the received monitor packet. Therefore, it is possible to improve an accuracy and reliability of the packet loss monitor for the transmission path in the transmission system 1.

According to the technology described above, it is possible to improve an accuracy of a signal connectivity monitor using a monitor signal such as the monitor packet.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. A transmission apparatus comprising:
a transmission counter configured to count a number of data signals transmitted to an internal signal route in the transmission apparatus;
a transmission counter value setting unit configured to set a transmission counter value of the transmission counter in a monitor signal to be transmitted to the internal signal route, the transmission counter value set in the monitor signal being counted at a timing when the monitor signal is transmitted to the internal signal route;
a reception counter configured to count a number of the data signals received from the internal signal route; and
a reception counter value setting unit configured to set a reception counter value of the reception counter into the monitor signal, the reception counter value set in the monitor signal being counted at a timing when the monitor signal is received from the internal signal route.

2. The transmission apparatus according to claim 1, further comprising a monitor configured to monitor presence or absence of loss of any one of the data signals in the internal signal route based on the transmission counter value and the reception counter value which are set in the monitor signal.

3. The transmission apparatus according to claim 1,
wherein the internal signal route is routed through different interface units of a plurality of interface units provided in the transmission apparatus,
wherein one of the different interface units is provided with the transmission counter and the transmission counter value setting unit, and
wherein the other of the different interface units is provided with the reception counter and the reception counter value setting unit.

4. A transmission system comprising:
a first transmission apparatus configured to transmit data signals to a transmission path; and
a second transmission apparatus configured to receive the data signals from the transmission path,
wherein the first transmission apparatus includes
a transmission counter configured to count a number of the data signals transmitted to the transmission path, and
a transmission counter value setting unit configured to set a transmission counter value of the transmission counter in a monitor signal to be transmitted to the transmission path, the transmission counter value set in the monitor signal being counted at a timing when the monitor signal is transmitted to the transmission path, and
wherein the second transmission apparatus includes
a reception counter configured to count a number of the data signals received from the transmission path, and
a reception counter value setting unit configured to set a reception counter value of the reception counter in the monitor signal, the reception counter value set in the monitor signal being counted at a timing when the monitor signal is received from the transmission path.

5. The transmission system according to claim 4, further comprising a monitor apparatus configured to monitor a presence or absence of loss of any one of the data signals in the transmission path based on a transmission counter value and a reception counter value which are set in the monitor signal.
